(19) United States
(12) Patent Application Publication
(10) Pub. No.: US 2002/0082741 A1
(43) Pub. Date: Jun. 27, 2002

(54) Fabrication of biomedical implants using direct metal deposition

(76) Inventors: Jyoti Mazumder, Ann Arbor, MI (US); Dwight Morgan, Rochester, MI (US); Timothy W. Skszek, Saline, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 09/916,976

(22) Filed: Jul. 27, 2001

Related U.S. Application Data
(60) Provisional application No. 60/221,249, filed on Jul. 27, 2000.

(51) Int. Cl. G06F 19/00

(52) U.S. Cl. 700/123

(57) ABSTRACT

Direct metal deposition (DMD^{tm}) is used to fabricate customized three-dimensional artificial joint components, thereby leading to enormous savings in terms of labor, cost and lead-time. The DMD fabrication process is interfaced directly to digital data derived through CAT scans, MRI or X-ray topography. A computer-aided design (CAD) file is then constructed in accordance with the digital data, and a tool path is generated as a function of the CAD file. The desired implant, or a portion thereof (such as just the outer surface) is then be fabricated by depositing material increments along the tool path using direct metal deposition (DMD). The process may be used for both solid and scaffold structure suitable to bone ingrowth or ongrowth. In the preferred mbodiment, a closed-loop DMD process is used wherein the size of the increments are controlled through optical monitoring. The materials forming the implant may include one or more metals, polymers, or ceramics, including zirconia or alumina. The same DMD process may also be used to fabricate the implant out of different materials, inlcuding a combination metals, ceramics, or polymers. As a further advantage, one or more sensors may be embedded into the implant during fabrication for diagnostic or data-acquisition purposes.

### REFERENCE TO RELATED APPLICATIONS

This application claims priority of U.S. Provisional Patent Application Serial No. 60/221,249, filed Jul. 27, 2000, the entire contents of which are incorporated herein by reference.

### FIELD OF THE INVENTION

This invention relates generally to additive manufacturing and, in particular, to the fabrication of customized biomedical implants using closed-loop direct metal deposition (DMD^{tm}).

### BACKGROUND OF THE INVENTION

More than 120,000 artificial hip joints are currently implanted annually in the United States. In addition, implants are routinely used for joints such as knee, shoulder and vertebrae. Such prosthetic devices are either fabricated from metal, ceramic, or a combination thereof. Metallic implants are typically made from cobalt-chromium, titanium or ferrous alloys. Titanium is preferred due to its strength to weight ratio. Ceramics such as zirconia (ZrO₂) and alumina (Al₂O₃) are also being used for improved wear resistance at the joint. New groups of polymers are claimed to offer improved wear resistant as well.

FIG. 1 shows a typical hip joint. The femoral head and stem are typically metallic. The femoral cup can be made of either polymer or ceramics encased in metals. At least a part of the femoral stem often uses porous metal for tissue growth and improved acceptance in the body.

Successful implants considerably improve the mobility and quality of life for the patient. Advances in the surgical procedure have diminished the risk associated with the operation. The result is increased popularity of the joint replacement however; each implant has to be customized for a specific patient. A study by the National Center for Manufacturing Sciences (NCMS) reports that 65 steps are involved in producing a customized femoral implant for a hip joint. Any fabrication technique capable of reducing the lead-time and improving the customization process will have tremendous impact on the prosthetics industry.

Fabrication of three-dimensional metallic components via layer-by-layer laser cladding was first reported in 1978 by Breinan and Kear. In 1982, U.S. Pat. No. 4,323,756 issued to Brown et al., which describes a method for the production of bulk, rapidly solidified metallic articles, finding particular utility in the fabrication of certain gas turbine engine components including discs and knife-edge air seals.

Recently, various groups around the world have been working on different types of layered manufacturing techniques for fabrication of near-net-shape metallic components. Recent innovations include the integration of lasers with multi-axis CNC machines and co-axial nozzles toward the fabrication of three-dimensional components.

However, previous approaches are all open-loop processes requiring either a considerable amount of periodic machining or final machining to achieve close dimensional tolerances. Continuous corrective measures during the manufacturing process are necessary to fabricate net shape functional parts with close tolerances and acceptable residual stress.

U.S. Pat. No. 6,122,564, the entire contents of which are incorporated herein by reference, describes a laser-based, direct metal deposition fabrication process capable of producing near net-shape, fully dense molds, dies, and precision parts, as well as engineering changes or repairs to existing tooling or parts. According to the process, an industrial laser beam is focused onto a workpiece, creating a melt pool into which powdered metal is injected. The beam is moved under CNC control, based on a CAD geometry, tracing out the part, preferably on a layer-by-layer basis. Optical feedback is preferably used to maintain tight closed-loop control over the process.

Initial data using an optical feedback loop along with a CNC working under the instructions from a CAD/CAM software, indicate that closed-loop DMD can be used to produce three-dimensional components directly from the CAD data, thereby eliminating intermediate machining and considerably reducing the amount of final machining. This technology is now being commercialized, with surface finishes on the order of 100 micron being routinely achievable. In addition to close-dimensional tolerances, the closed-loop DMD process enables fabrication of components with multiple materials.

### SUMMARY OF THE INVENTION

This invention broadly takes advantage of the fact that direct metal deposition (DMD) may be used to fabricate customized three-dimensional components directly from CAD data. As such, the process is used according to this invention to reduce the number of steps associated with artificial joint fabrication, thereby leading to enormous savings in terms of labor, cost and lead-time.

In the preferred embodiment, the DMD fabrication process is interfaced directly to digital data derived through CAT scans, MRI or X-ray topography. A computer-aided design (CAD) file is then constructed in accordance with the digital data, and a tool path is generated as a function of the CAD file. The desired implant, or a portion thereof (such as just the outer surface) may then be fabricated by depositing material increments along the tool path using direct metal deposition (DMD). The process may be used for both solid and scaffold structure suitable to bone ingrowth or ongrowth.

In the preferred embodiment, a closed-loop DMD process is used wherein the size of the increments are controlled through optical monitoring. The materials forming the implant may include one or more metals, polymers, or ceramics, including zirconia or alumina. The same DMD process may also be used to fabricate the implant out of different materials, inlcuding a combination metals, ceramics, or polymers. As a further advantage, one or more sensors may be embedded into the implant during fabrication for diagnostic or data-acquisition purposes.

### BRIEF DESCRIPTION OF THE DRAWINGS

FIG. 1 is a drawing which shows a typical prosthetic hip joint; and

FIG. 2 is a flow chart illustrating the fabrication of a patient-specific implant using the direct-metal deposition process.

### DETAILED DESCRIPTION OF THE INVENTION

According to this invention, direct metal deposition (DMD) is used to fabricate customized prosthetic joint implants for both human and veterinary applications. An important aspect of the approach involves the integration of the digital patient data for fabrication and close-dimensional tolerance for complicated shapes.

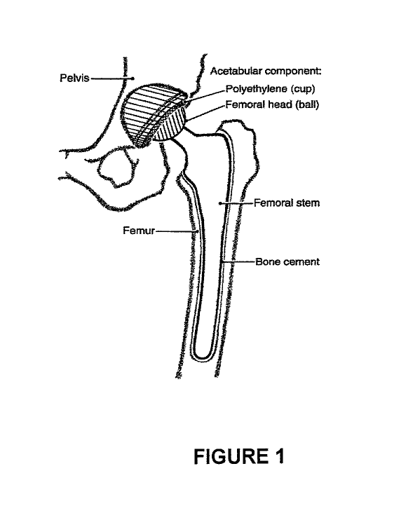

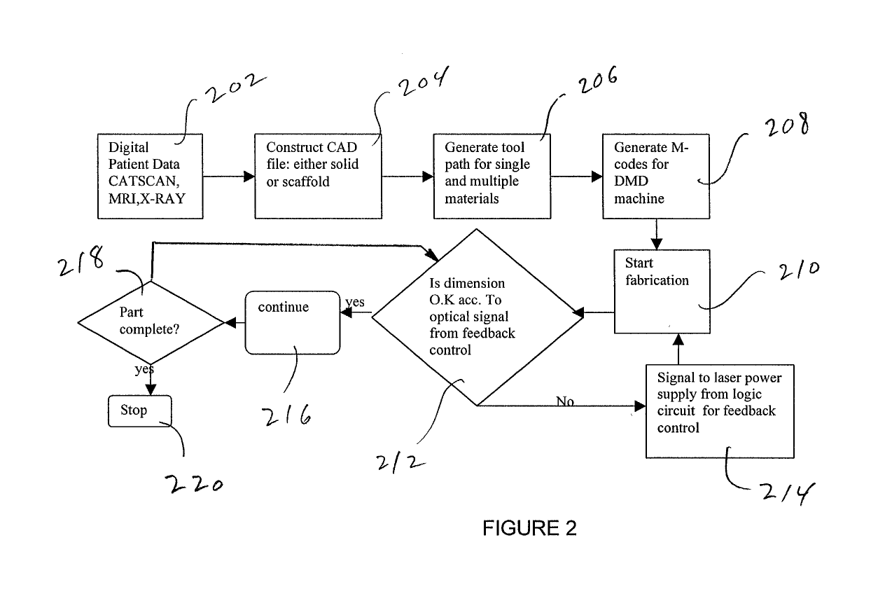

Having discussed FIG. 1, reference is made to FIG. 2, which depicts a flow chart associated with the fabrication of a patient-specific implant using DMD. At block 202, digital patient data is received in one of a variety of forms, including CAT scans, MRI, X-rays, and so forth. A CAD file is constructed in accordance with the digital data received at block 204, this CAD file may also be in different forms, including solid or scaffold-type models. At block 206, tool paths are generated for single or multiple materials, as the case may be for a particular type of implant. MCAT-codes specific to the DMD machine are generated at block 208, and fabrication is initiated at block 210 in accordance with these codes.

At decision block 212, the question is asked whether dimensional accuracy is acceptable based upon the optical feedback control of the closed-loop process. If not, the signal to the laser power supply (or other parameters, such as material feed, etc.) is adjusted at 214, with fabrication continuing at block 210, thereby creating a closed loop consisting of blocks 210, 212, 214.

If dimensional accuracy is acceptable, the process continues utilizing the existing fabrication parameters at 216 until the part is complete. This question is asked at decision block 218, and if the answer is yes, the system stops, as the part has been fabricated. If the part is not complete, the system loops back to decision block 212, again asking the decision if dimensional accuracy is acceptable.

Dimensional accuracy is best achieved with the closed-loop feedback control. At least the height dimension of the deposit is preferably controlled using the optical feedback loop as described in the U.S. Pat. No. 6,122,564. Alternatively, an image of the deposit may be projected onto a linear or two-dimensional detector array and counting the illuminated pixels to monitor width or other characteristics of the deposit. Thus, a similar result may be obtained by monitoring the video signal used for the visual inspection of the process. In addition to dimensional control, residual stress may also be reduced in accordance with the teachings of U.S. patent application Ser. No. 60/142,126, filed Jul. 2, 1999, the entire contents of which are also incorporated herein by reference.

As a further advantage, a significant capability made possible with DMD is the ability of depositing different materials at different locations. The feedback loop can account for the deposition behavior of different material and maintain a close dimensional tolerance. For example, a femoral head (or other component) may be fabricated with an alumina or zirconia coating through the deposition of Al or Zr in the presence of oxygen. Also, with respect to the deposition of porous material, DMD can be used to fabricate the scaffold for better fixation and increased tissue growth. DMD also allows incorporation of sensors during the fabrication process for future diagnostics and data acquisition.

Another design flexibility is the ability to incorporate intricate shapes needed for some joints. For example, the deepened trochlear groove design of Sulzer Medica allows smooth articulation of the patella through a full range of motion. That design involves three different planes with 10°, 45° and 90° angles. Fabrication of such shape in conventional methods will take multiple steps, but with DMD, this can be done with relative ease.

We claim:

1. A method of fabricating at least a portion of a biomedical implant, comprising the steps of:
receiving digital data indicative of patient physiology;
constructing a computer-aided design (CAD) file in accordance with the digital data;
generating a tool path; and
fabricating the implant or portion thereof by depositing material increments along the tool path using direct metal deposition (DMD).

2. The method of claim 1, further including the step of using a closed-loop DMD process, wherein the size of the increments are controlled through optical monitoring.

3. The method of claim 1, wherein the materials include one or more metals or ceramics.

4. The method of claim 1, wherein the materials include zirconia or alumina.

5. The method of claim 1, further including the step of fabricating the implant out of different materials using the same DMD process.

6. The method of claim 5, wherein the different materials include metals, ceramics, or polymers.

7. The method of claim 1, further including the step of embedding one or more sensors into the implant for diagnostic or data-acquisition purposes.

8. The method of claim 1, further including the step of fabricating a scaffold structure suitable to bone ingrowth or ongrowth using the DMD process.
